(19) United States
(12) Patent Application Publication
(10) Pub. No.: US 2003/0167885 A1
(43) Pub. Date: Sep. 11, 2003

(54) Wrench adapted for lever arm extension

(76) Inventors: Bruce S. Coggins, Magna, UT (US); Brandon R. Luke, Magna, UT (US)

Correspondence Address: BRIAN C. TRASK, 3601 EAST HERMES DRIVE, SALT LAKE CITY, UT, 84124, US

(21) Appl. No.: 10/091,042

(22) Filed: Mar. 6, 2002

(51) Int. Cl. B25B 23/16

(52) U.S. Cl. 81/177.2

(57) ABSTRACT

A first wrench adapted at one or both ends to receive an end of a second wrench to permit use of the second wrench as a lever arm extension to the first wrench. The invention provides a reliable coupling of the two wrenches. The first wrench may be a box or a combination wrench. An open-end portion of a second wrench is interlocked through a box-end of the first wrench. A slot structure on the first wrench can transform a torque from the second wrench to an augmenting force to increase a torque applied by the first wrench on a bolt or nut. The slot may be complimented by a notch located diametrically opposite, and on an opposite side of the box-end, from the slot. If present, a notch receives handle structure of the second wrench.

### BACKGROUND OF THE INVENTION

1. Field of the Invention

This invention relates generally to hand tools. It is particularly directed to wrenches used to couple and decouple nuts and bolts.

2. State of the Art

Hand tools, including wrenches of various kinds, are well known. Wrenches are used commonly to couple and decouple nuts and bolts. Some times, a nut may be stuck on a bolt, requiring a significant torque to be generated by a wrench to effect its removal. In certain cases, a lever arm extension, or “cheater bar” may be employed to increase leverage on the wrench, and correspondingly increase the torque applied on the nut. Sections of pipe, sixed to fit over an end of the wrench, may be employed. However, there are occasions when a suitable pipe is not available. At other times, the space surrounding a stuck bolt is limited, precluding use of a long pipe.

In certain cases, mechanics faced with a stuck, stubborn nut may desire to link a second wrench to the primary nut turning wrench, to provide a lever arm to the primary wrench. Such an extension may produce sufficient additional torque to remove the stubborn nut, and also create a leveraged wrench that fits into the available space. Open ends of open-end wrenches have tines that will fit into the closed ring-end portions of commercially available wrenches having a box-end, seemingly to form a desired extension arm. Unfortunately, such an arrangement produces an unreliable lever arm which inherently will buckle out-of-plane under an applied load. When such an arrangement inevitably buckles, the mechanic is quite likely going to receive a skinned knuckle for his effort.

It would be an improvement in the art to provide a wrench with a box-end, structured to receive an open-end of a second wrench, for reliable use as a lever arm extension.

### BRIEF SUMMARY OF THE INVENTION

The present invention provides an apparatus for coupling and decoupling nuts and bolts with a hand operated wrench adapted to receive a second wrench as a reliable lever assist. The invention provides structure to create a reliable coupling between two wrenches. The coupling structure prevents buckling of the junction between wrenches to maintain an alignment between handle axes in the respective wrenches.

An apparatus structured according to the present invention typically includes a slot in a ring-socket of a primary wrench having a box end. The slot is disposed at the junction between a wrench handle and the ring-socket. Certain wrenches may be formed to have a slot not passing through a ring-socket, or to have alternative structure equivalent to a slot. Desirable slots will accommodate a range of thicknesses of tines to accommodate a variety of sizes in open-end wrenches. A notch may be included in certain embodiments of the invention. A notch, if included, is disposed diametrically opposite a slot, and on an opposite side of the ring-socket. The notch is adapted to interface with a handle portion of the second wrench. A slot and a notch, in combination, may convert an applied torque from the second wrench to an augmenting force on the primary wrench's handle. In certain embodiments, the slot itself will convert an applied torque from the second wrench to an augmenting force on the primary wrench's handle. The augmenting force increases a torque applied to a nut by the primary wrench.

These features, advantages, and alternative aspects of the present invention will be apparent to those skilled in the art from a consideration of the following detailed description taken in combination with the accompanying drawings.

### BRIEF DESCRIPTION OF THE SEVERAL VIEWS OF THE DRAWINGS

In the drawings, which illustrate what are currently considered to be the best modes for carrying out the invention:

FIG. 1 is a plan view of a prior art wrench;

FIG. 2 is a top view in perspective of an end portion of a prior art wrench;

FIG. 3 is a bottom view in perspective of the end portion illustrated in FIG. 2;

FIG. 4 is a top view in perspective of an end portion of a wrench according to principals of the invention;

FIG. 5 is a bottom view in perspective of the end portion illustrated in FIG. 4;

FIG. 6 illustrates a portion of a second wrench positioned in engagement with an end portion of a first wrench according to the invention to provide a lever arm extension;

FIG. 7 illustrates a portion of a second wrench in an alternative orientation for engagement with an end portion of a first wrench according to the invention to better align longitudinal axes of the first and second wrenches;

FIG. 8 is a cross-section view in elevation through an end portion of an alternative embodiment of the invention;

FIG. 9 is a cross-section view in elevation through an end portion of another alternative embodiment of the invention;

FIG. 10 is a cross-section view in elevation through an end portion of yet another alternative embodiment of the invention.

### DETAILED DESCRIPTION OF THE INVENTION

Reference will now be made to the drawings in which the various elements of the invention will be given numerical designations and in which the invention will be discussed so as to enable one skilled in the art to make and use the invention. It is to be understood that the following description is only exemplary of the principles of the present invention, and should not be viewed as narrowing the claims which follow.

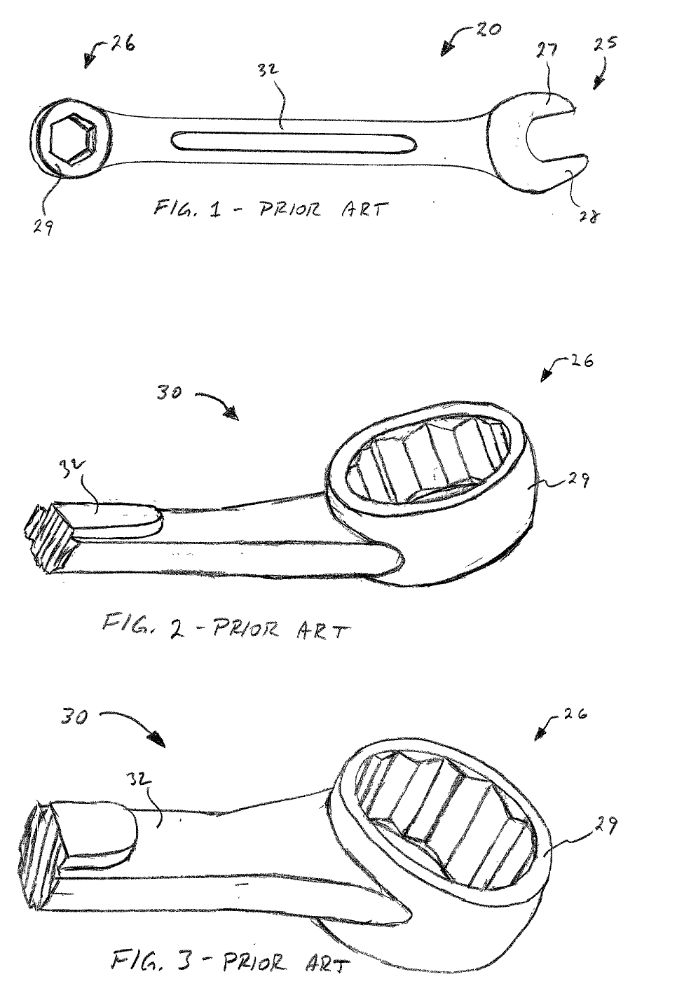

FIG. 1 illustrates a prior art wrench, generally indicated at 20. Wrench 20 is a combination wrench, having an open-end 25, and a box-end 26. Open end 25 has a pair of tines 27 and 28, configured to interface with opposite flats of a nut or bolt. Box-end 26 is illustrated having a ring-socket 29 having 6 points to fit to a hex head bolt or nut. A portion of an alternative wrench, generally indicated at 30 in FIGS. 2 and 3, has a box-end 26 with a ring-socket 29 having 12 points. The invention is equally operable in wrenches having either 6- or 12-point ring-sockets. Wrenches of the type usable with the present invention include a handle 32 disposed between opposite ends of the wrench.

Sometimes a person attempting to turn a stubborn nut or bolt with a first wrench is tempted to create a lever arm extension to the first wrench by coupling a second wrench by its box-end to an open-end portion of the first wrench, where the coupling occurs at an end of the first wrench opposite the stubborn nut (see FIGS. 6 and 7). However, such a coupling is inherently unstable, as anyone who has attempted such coupling it is aware. Under an applied load to loosen the stubborn nut, the extension wrench unavoidably buckles, rotating relative the first wrench, in a direction transverse to the applied load. Commercially available box-end wrenches simply do not provide structure suitable to avoid the transverse rotation between two wrenches coupled in the manner described immediately above. While such coupling may appear, at first glance, to be stable, only a small amount of friction, from a metal-on-metal contact (with an inherently low coefficient of friction) resists out-of-plane rotation of the extension wrench about the coupling location. Even a tiny vibration may be enough to cause the wrenches to buckle under load, probably also resulting in a bashing of the knuckles of the wrench wielder against a local obstruction.

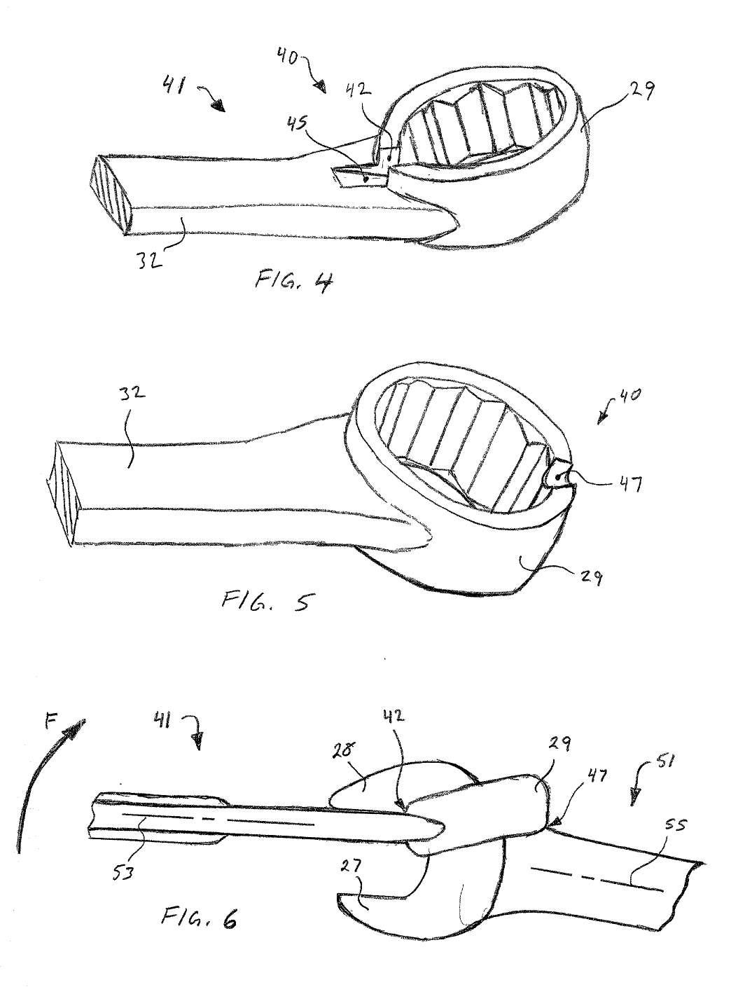

A solution to the problem of intrawrench buckling is provided by the invention, which introduces alignment structure, generally indicated at 40, carried on a portion of a wrench, generally illustrated at 41 in FIG. 4, to resist undesired relative wrench rotation. Alignment structure 40 may include a channel 42 through a portion of ring-socket 29 of wrench 41. Channel 42 is sized having a span between its edges sufficient in width to receive a tine portion of an open-end wrench. In addition to a channel 42, or even alternatively, a slot 45 may be formed at the junction between a handle 32 and a ring-socket 29.

FIG. 5 illustrates the opposite side of the portion of wrench 41 from FIG. 4. A notch 47 is disposed diametrically opposite, and on the opposite side of the ring-socket 29, from the channel 42. The notch 51 is configured to receive edge structure of a handle of a second wrench. As may be visualized in FIG. 6, channel 42 and notch 47 together create a structural interference with an end of a second wrench, generally indicated at 51, to resist buckling of the wrenches in a direction out-of-plane from an applied load indicated by arrow F. That is, wrench 41 is prevented from rotating out of the plane of the page by the structural interference between channel 42, notch 47, and structure of wrench 51.

FIGS. 6 and 7 illustrate alternative workable arrangements to use wrench 41 as a lever arm extension for a primary wrench 51. Either of tine 27 or tine 28 may be received in a ring-socket 29 to form a coupling between wrenches 41 and 51. The two configurations illustrated in FIGS. 6 and 7 are the most structurally favorable for augmenting torque on a nut by a primary wrench. The second wrench 41 is loaded transverse to the plane of ring-socket 29 to transmit the augmented torque. Alignment structure 40 simply prevents intrawrench buckling.

Although not as inherently strong or stable, it is possible also to use alignment structure 40 as a torque transmitting structure. In such alternative use, wrench 41 in FIGS. 6 and 7 would be the primary wrench, in engagement with a nut or bolt on an opposite end not illustrated. Wrench 51 would operate as the lever arm extension to wrench 41. To increase a torque on the nut, wrench 51 would be raised or lowered perpendicular to the page. The configuration illustrated in FIG. 7 would be more favorable over the configuration of FIG. 6, because such configuration, with tine 27 in engagement in ring-socket 29, places a longitudinal axis 53 of wrench 41 more in alignment with axis 55 of wrench 51. In FIG. 6, the angle between axis 55 and axis 53 may cause an undesired rotation of wrench 41 about axis 53.

However, the coupling between wrenches in such alternative use is not as reliable as when wrench 41 is used as a lever extension to primary wrench 51. In the alternative use, wrench 51 must simultaneously be pressed transversely (vertically as illustrated in FIGS. 6 and 7) as it is raised or lowered in and out of the page to apply a leveraged force on a nut. The transverse force must be applied to maintain alignment structure 40 in engagement between the two wrenches. In the preferred configuration, the additional leverage force applied to wrench 41, used as an extension lever, automatically engages alignment structure 40 between the two wrenches.

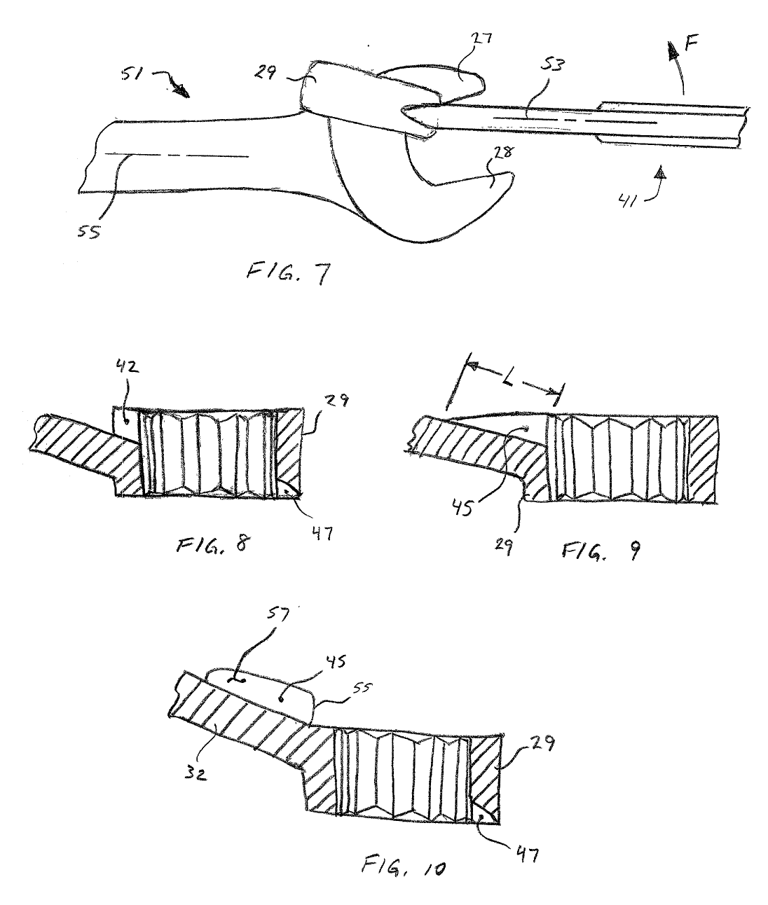

FIGS. 8, 9, and 10 illustrate some alternative embodiments for alignment structure 40. FIG. 8 shows a ring-socket 29 having a channel 42 and a diametrically opposite notch 47. The embodiment of FIG. 9 has a slot 45 in which to receive a tine 27 or 28. Slot 45 has a length L operable to stop intrawrench rotation between two coupled wrenches. As illustrated in FIG. 9, in certain embodiments, a notch may not be required. FIG. 10 shows an alternative arrangement to form a slot 45 by structure 55 carried on handle 32. A pair of structures 55 are spaced apart on handle 32 to receive between them a tine 27 or tine 28. Surface 57 engages the tine and stops intrawrench rotation of coupled wrenches. A notch 47 may be present in some embodiments, such as illustrated in FIG. 10.

While the invention has been described in particular with reference to certain illustrated embodiments, such is not intended to limit the scope of the invention. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An improved first wrench, comprising:
alignment structure carried on one end of said first wrench and adapted to receive an end portion of a second wrench, said alignment structure being configured and arranged in harmony with said end portion to resist rotation, in a direction out-of-plane from an applied force on said first wrench, of said second wrench with respect to said first wrench whereby to permit reliable use of said second wrench as a lever arm extension to said first wrench.

2. The wrench according to claim 1, said alignment structure comprising:
a channel disposed at a junction of a handle and a ring-socket of a box-end wrench.

3. The wrench according to claim 2, said channel being configured and arranged on one side of said first wrench to form a structural interference with a tine of a fork of an open-ended second wrench, said structural interference being operable to resist a torque transmitted by said tine and generated by use of said second wrench as a lever arm extension to said first wrench.

4. The wrench according to claim 2, said alignment structure further comprising a notch in said ring-socket, said notch being disposed diametrically opposite and on an opposite side of said ring-socket from said channel.

5. The wrench according to claim 4, said notch being configured and arranged to form a structural interference with a handle portion of said second wrench.

6. The wrench according to claim 2, said channel further comprising slot structure formed on a handle near a junction between said handle and said ring-socket.

7. The wrench according to claim 2, said channel structure being sized to accommodate a plurality of second wrenches providing end portions having a plurality of thicknesses.

8. The wrench according to claim 3, said channel structure being sized to accommodate a plurality of second wrenches providing a plurality of tines having a plurality of individual thicknesses.

9. An improved wrench set, said set comprising a plurality of individual primary wrenches, each primary wrench being adapted on a first end to form a structural interference fit with torque transferring structure carried on a second end of a different wrench, said structural interference permitting reliable use of said different wrench as a lever arm extension to said primary wrench.

10. The wrench set according to claim 9, each of said primary wrenches comprising a box-end disposed at a first end of a handle.

11. The wrench set according to claim 9, each of said primary wrenches comprising a box-end disposed at first and second ends of a handle.

12. The wrench set according to claim 9, each of said primary wrenches comprising a box-end disposed at a first end of a handle and an open-end disposed at a second end of said handle.

13. The wrench set according to claim 9, wherein:
said structural interference fit is developed by structure comprising a slot and a notch being mutually adapted to interface with structure of a said different wrench;
said slot being disposed at a junction between a handle of said primary wrench and a ring-socket, and being configured to receive a tine of an open-end portion of said different wrench; and
said notch being disposed diametrically opposite and on an opposite side of said ring-socket from said slot, and configured to interface with a handle portion of said different wrench.

14. An improved wrench having alignment structure configured to prevent buckling, out-of-plane from an applied force on said improved wrench, reliably to permit use of a second wrench as a lever arm extension to said improved wrench.

15. The wrench according to claim 14, said alignment structure comprising an adapter configured and arranged to transfer a torque generated by said second wrench into an augmenting force on a handle of said improved wrench to increase a bolt turning torque at an opposite end of said improved wrench.

16. The wrench according to claim 15, said adapter being configured to transfer a torque applied by a tine of an open-ended second wrench into an augmenting force on said handle.

17. The wrench according to claim 14, said alignment structure comprising a box-end portion adapted to interface in a structural interference with a tine of an open-end portion of a second wrench.

18. The wrench according to claim 17, said alignment structure further comprising a slot disposed at a handle junction to said box-end.

19. The wrench according to claim 18, said alignment structure further comprising a notch in said box-end, said notch being disposed diametrically opposite and on an opposite side of said box-end from said channel, said notch and channel cooperating to resist rotation of said second wrench with respect to said improved wrench.
